(19) United States
(12) Patent Application Publication
(10) Pub. No.: US 2012/0127012 A1
(43) Pub. Date: May 24, 2012

(54) DETERMINING USER INTENT FROM POSITION AND ORIENTATION INFORMATION

(75) Inventors: Daniel P. GICKLHORN, Irvine, CA (US); Dang TRAN, Laguna Niguel, CA (US); Michael R. LOVELACE, Irvine, CA (US); Andrew R. SHELANSKY, Irvine, CA (US)

(73) Assignee: SAMSUNG ELECTRONICS CO., LTD., Suwon City (KR)

(21) Appl. No.: 13/085,375

(22) Filed: Apr. 12, 2011

Related U.S. Application Data
(60) Provisional application No. 61/416,979, filed on Nov. 24, 2010.

(51) Int. Cl. H04L 17/02; G01S 15/08; G01C 3/08; G05B 19/00

(52) U.S. Cl. 341/176; 340/5.1; 367/99; 356/4.01

(57) ABSTRACT

In a first embodiment of the present invention, a method for controlling a receiving device, the method comprising: detecting a position of a control device operated by a user; detecting horizontal orientation or vertical inclination of the control device; based on the position and the horizontal orientation or vertical inclination of the control device, determining that the control device is pointed at the receiving device as opposed to another receiving device in the vicinity; and causing the control device to control the receiving device at which it is pointed based on the determination that the control device is pointed at the receiving device.

### CROSS REFERENCE TO RELATED APPLICATIONS

This application claims the benefit of priority under 35 U.S.C. 119(e) to U.S. Provisional Patent Application No.: 61/416,979, filed Nov. 24, 2010, which is incorporated herein by reference for all purposes.

### BACKGROUND OF THE INVENTION

1. Field of the Invention

The present invention relates to consumer electronics. More specifically the present invention relates to the determining of user intent from position and orientation information.

2. Description of the Related Art

The explosion of network-enabled consumer devices in recent years has given rise to a relatively new phenomenon in that is becoming more and more common for individual rooms in a house (such as a living room) to contain a number of different network-enabled devices. For example, it is not uncommon for a living room to contain a network-enabled television, network-enabled DVD or Blu-ray player, network-enabled digital picture frames, a network-enabled stereo system, network-enabled light fixtures/switches, network-enabled video game systems, etc. Furthermore it has become common for users to carry with them network-enabled devices, such as Internet-capable smartphones and tablet computers, not to mention laptop or desktop computers. Other household devices have also become network-enabled in recent years, including printers, refrigerators, and ovens.

The primary control (to the extent external control of the devices was provided) in these rooms has traditionally been the television remote control. In most households, the television remote is the control that is typically the center of attention, since television viewing is a common communal activity for families. Other devices, to the extent that they permitted control remotely, provide their own dedicated remote controls. As the number of these devices increased, however, the number of remote controls that were required to be used grew unwieldy. Consumers generally prefer simplicity, and having fewer (ideally one) remote control is much more preferable than having many.

One prior art solution was the introduction of the universal remote control. The universal remote control allows for control of more than just a single device, typically by entering codes for other manufacturers' devices or by training the remote control to duplicate infrared signals generated by other remote controls. The drawback to this approach, however, is that it requires dedicated buttons on the remote for the various components to be controlled (or, at least, a switch allowing the user to change between which component is being controlled).

What is needed is a solution that allows a user to control multiple devices from a single control without requiring dedicated buttons or switches.

### SUMMARY OF THE INVENTION

In a first embodiment of the present invention, a method for controlling a receiving device, the method comprising: detecting a position of a control device operated by a user; detecting horizontal orientation or vertical inclination of the control device; based on the position and the horizontal orientation or vertical inclination of the control device, determining that the control device is pointed at the receiving device as opposed to another receiving device in the vicinity; and causing the control device to control the receiving device at which it is pointed based on the determination that the control device is pointed at the receiving device.

In a second embodiment of the present invention, a control device is provided, comprising: a position sensor designed to track position of the control device with respect to two or more receiving devices in proximity of the control device; an orientation sensor designed to track horizontal orientation of the control device; and an eventing module designed to determine at which of the two or more receiving devices the control device is pointing, based upon the tracked position and horizontal orientation, and to generate an event to the corresponding receiving device based upon that determination.

In a third embodiment of the present invention, a first receiving device is provided, the first receiving device comprising: a position sensor designed to track position of a control device in proximity of the first receiving device; and an event receiver designed to receive an event generated by the control device, wherein the event indicates a pairing between an indicated receiving device and the control device based upon a determination that the position of the control device and the orientation of the control device evidence a user intent to control the indicated receiving device.

In a fourth embodiment of the present invention, a system is provided comprising: a plurality of receiving devices; a control device comprising; means for detecting the position of the control device; means for detecting horizontal orientation or vertical inclination of the control device; means for, based on the position and the horizontal orientation or vertical inclination of the control device, determining that the control device is pointed at a particular one of the receiving devices as opposed to another receiving device in the vicinity; and means for causing the control device to control the receiving device at which it is pointed.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a diagram illustrating an example system in accordance with an embodiment of the present invention.

FIG. 2 is a block diagram illustrating various components of a system in accordance with an embodiment of the present invention.

FIG. 3 is a flow diagram illustrating the flow on a control device in accordance with one embodiment of the present invention.

FIG. 4 is a block diagram illustrating the architecture of a receiving device in accordance with one embodiment of the present invention.

FIG. 5 depicts a top view of a system including a control device and receiving devices in accordance with an embodiment of the present invention.

FIG. 6 is a diagram illustrating relative vertical inclination measuring in accordance with an embodiment of the present invention.

FIG. 7 is a diagram illustrating relative horizontal orientation measuring in accordance with an embodiment of the present invention.

FIG. 8 is a diagram illustrating pictorially a non-vertically calibrated target and a horizontally and vertically calibrated target in accordance with an embodiment of the present invention.

FIG. 9 is a diagram illustrating calibration in accordance with an embodiment of the present invention.

FIG. 10 is a diagram illustrating a process of translation between positions of a device in accordance with an embodiment of the present invention.

FIG. 11 is a diagram illustrating calibrating a virtual device in accordance with an embodiment of the present invention.

FIG. 12 is a high level block diagram showing an information processing system in accordance with an embodiment of the present invention.

### DETAILED DESCRIPTION OF THE INVENTION

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

In an embodiment of the present invention, a single control device may be used to control multiple devices at a single location by using position and orientation information to determine the user's “intent” (which device the user wishes to control). Specifically, the user may point the single control device at the device he or she wishes to control, and the system may utilize position and orientation information regarding the single control device to determine at which device the user is pointing. The system is then able to automatically control the correct device on behalf of the user.

One embodiment of the present invention leverages the use of an already integrated platform on hand held platform (HHP) devices such as smartphones to distribute the work of user identification and distribution of the processing load. The HHP device can be used to enrich a device/application/media interface with the use of an interactive, intelligent, and correlative interface.

A system may be provided that is capable of detecting user “intent” in a localized, distributed, multi-dimensional device tracking scenario utilizing a combination of position, orientation and/or inclination sensing devices or systems. The combination of these sensory inputs in conjunction with minimal user input on a portable hand-held platform allows the definition and detection of a user's intent.

For example, the present invention could be utilized in a device discovery scenario wherein the user is able to point the hand-held device toward another device and establish a direct pairing between the devices. In one particular example, a volume level control displayed on a screen of a smart phone can control the volume of the television if the system determines that the smart phone is aiming towards the television, whereas the same volume level control can control the volume of the stereo system if the system determines that the smart phone is aiming towards the stereo system.

The present invention also differs from prior art position-based pointing devices, such as those currently popular in video game systems, by virtue of the fact that it does not require expensive dedicated hardware to track movement and that it can be made compatible with any device that is brought into proximity of the system. The prior art video game position trackers require dedicated hardware such as infrared LEDs or cameras on top of the television to track movement and may only detect orientation with respect to that dedicated hardware.

For purposes of this document, the device the user controls to operate other devices is known as a “control device.” The prime example of a control device is a HHP, but nothing in this disclosure is limited to such an embodiment. Also for purposes of this document, the device the user controls using the control device is known as a “receiving device”. In some cases the receiving device may contain hardware or software designed to aid in the tracking of one or more of position, orientation, or inclination. Embodiments are possible, however, where the receiving device contains no such capability at all and the control device controls it as a “virtual receiving device.”

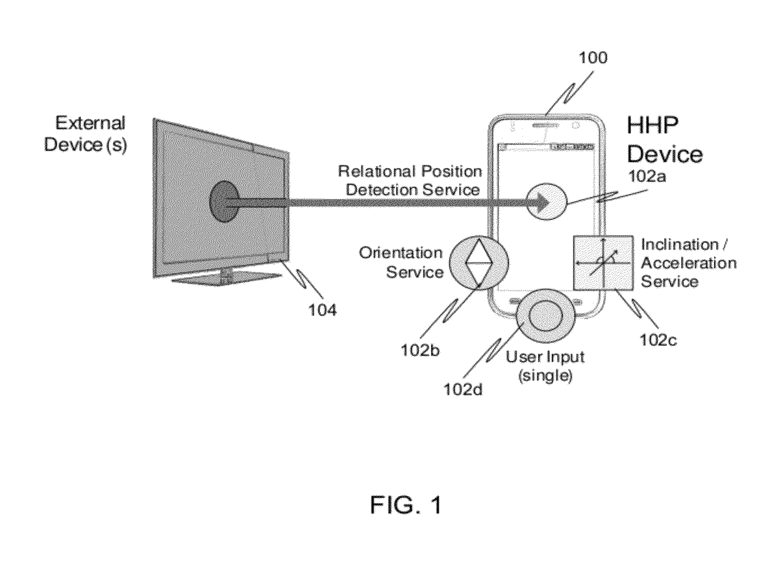

In an embodiment of the present invention, an internal horizontal orientation detecting device (e.g., compass or gyroscope) or other system capable of detecting linear orientation is combined with a position tracking system to detect at which receiving device a user is directing a control device. In one embodiment, an internal inclination or acceleration detecting device (e.g., accelerometer or gyroscope) is added to the system to allow for differentiation between devices in the vertical plane. FIG. 1 is a diagram illustrating an example system in accordance with an embodiment of the present invention. Here, the control device 100 (which is depicted as, but not intended to be limited to, a smart phone device), utilizes four sensor devices 102a-102c or like-yielding sub-systems to detect its relative position to local external receiving devices (one of which is depicted here as a television 104). The control device 100 does not require a screen or display device as the detection merely yields an internal event that need not be directly visible to the user.

The control device 100 can possess a programmable computing platform and possess either internally, or connected locally, a system or sensor 102a capable of producing proximity and positional information with relation to a compatible external receiving device that can update either on an interval or immediately when changed. Optionally, the control device can also possess, either internally or connected locally, a system or sensor 102b capable of producing orientation with relation to a fixed point or other known position relative to the receiving device. Optionally, the control device 100 can also contain, either internally or connected locally, a system or sensor 102c capable of detecting and producing inclination of the device with relation to a fixed point or other known position relative to the device. Also optionally, the control device 100 can possess, either internally or connected locally, a system or sensor 102c capable of detecting and producing acceleration or movement of the device with relation to a fixed point or other known position relative to the device. It should be noted that in this embodiment there is only one sensor 102c that measures both inclination and acceleration. In other embodiments these may be different sensors. The control device 100 can also possess, either internally or connected locally, a system or sensor 102d capable of detecting user input at a minimum of a single input deviant (e.g., button press). The control device 100 can also possess a form of local data storage (not pictured) and the ability to notify, either internally or externally, another process or portion of code within the system of the data from the sensors (also not pictured).

At least one of the external receiving devices should possess some compatible system, either externally or internally, that is able to track proximity and position information with relation to the handheld device or enable such tracking between itself and the control device. It should also possess some fixed (temporarily or permanently) physical form of representation to the user. It should be noted that it is not necessary that every external device that a user may wish to control contain the ability to track proximity and position information or be able to enable such tracking between itself and the control device. Embodiments are foreseen wherein an external device with the ability to track proximity and position information is used to track proximity and position information of the handheld device with respect to another external device lacking the ability to track proximity and position information. This will be described in more detail herein later in this document.

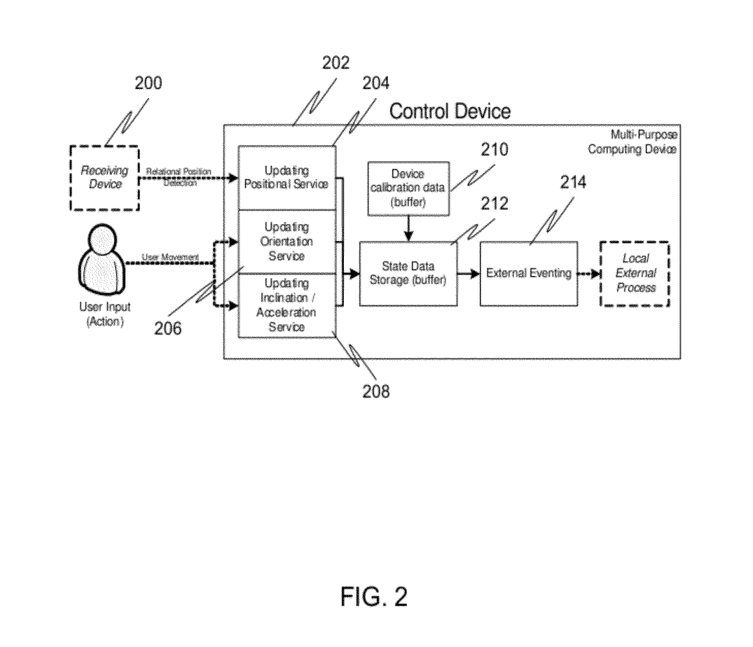

FIG. 2 is a block diagram illustrating various components of a system in accordance with an embodiment of the present invention. A receiving device 200 is able to track relational position of a control device 202. The control device 202 may contain an updating position service 204. This component utilizes access to an internal or external sensing device or system capable of detecting and producing a relationship between local devices and their relative positions with respect to the local handheld device, accessible by the programmable platform on the device. For example, relative GPS locations, sonic distance measurement, RFID detector array, optical (camera) distance detection and measurement, etc. may be used to track position.

The control device 202 may also contain an updating orientation service 206. This component utilizes access to an internal or external sensing device or system capable of detecting and producing a relationship between the orientation of the device with respect to some permanent position at a particular time, accessible by the programmable platform on the device. For example, a compass sensor, a gyroscopic sensor, or a system utilizing a combination of one or more sensors to estimate current orientation state may be used to track orientation.

The control device 202 may also contain an updating inclination and/or acceleration service 208. This component utilizes access to an internal or external sensing device or system capable of detecting and producing a relationship between the inclination of the device with respect to some local position on the device at a particular time, accessible by the programmable platform on the device. For example, an accelerometer system, a gyroscopic sensor, or a system utilizing a combination of one or more sensors to estimate current inclination state may be used to track inclination.

The control device 202 may also contain a device calibration data storage 210 and state data storage 212. Calibration data storage 210 stores calibration data for the various sensors on or controlled by the control device, whereas the state data storage 212 stores data relating to what the sensors are currently sensing (position, orientation, inclination).

The control device 202 may also contain an external eventing module 214. This component utilizes access to an internal or external device or system with the ability to notify another process or portion of code within the system, accessible by the programmable platform on the device. For example, an external inter-process eventing interface, a callback interface, an external network emission related to a notification event or other functional interface for notifying external components within or outside the handheld device host system may be used to notify another process or portion of code within the system.

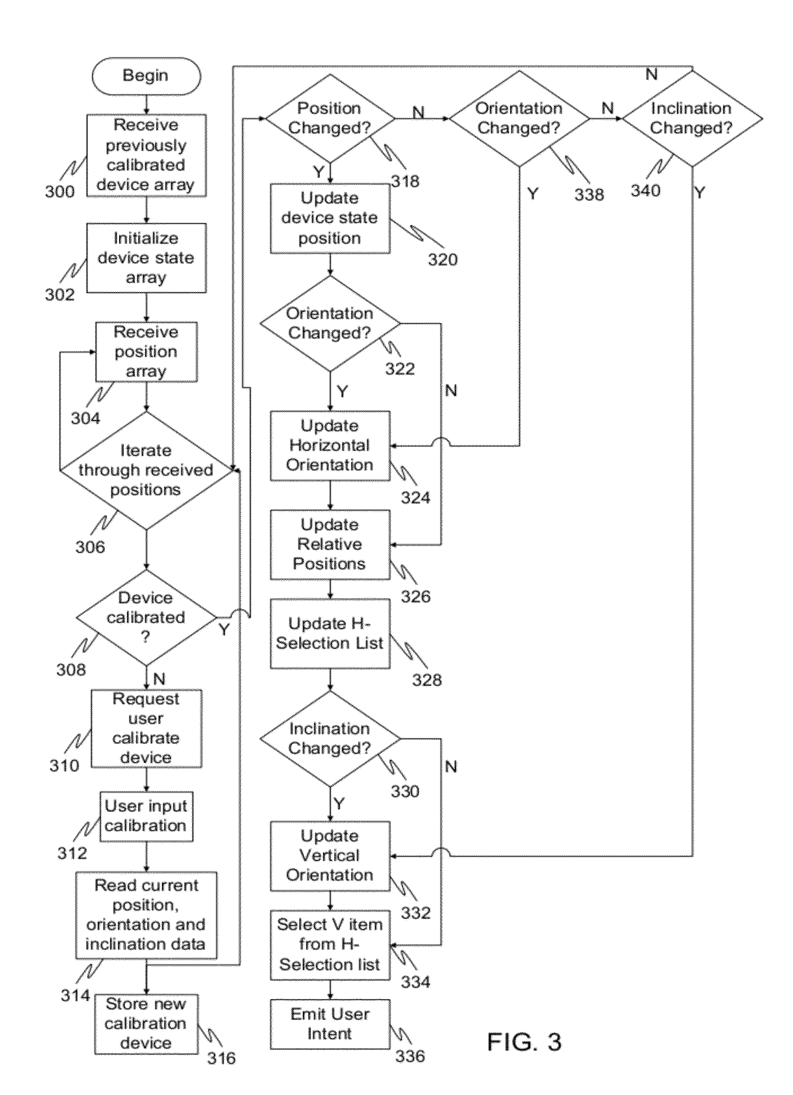

The components listed above can be described as operating through various functions. FIG. 3 is a flow diagram illustrating the flow on a control device in accordance with one embodiment of the present invention. At 300, a previously calibrated device array may be received. This device array may contain various information regarding the control devices that were set up during previous calibration events. It should be noted that if this is the first time a device is being calibrated, a device array may be created at this point. At 302, a device state array is initialized. This device state array contains state information regarding the position, horizontal orientation, and vertical inclination of the device. At this point, all of this state information is reset to allow for clean calibration. Once again, if this is the first time the control device is being calibrated, then the device state array may be created at this point. At 304, a position array may be received. This position array may contain information about the previously recorded positions of the control device(s). At 306, the received positions may be iterated through. For each of the received positions, the rest of the flow diagram may be followed.

At 308, it is determined if the device has been calibrated. If not, then at 310 a request may be made to the user to calibrate the device. At 312, the user provides calibration information by pointing the control device at the designated receiving device and providing a minimum of a single input deviant (e.g., button press). At 314, the current position, orientation, and inclination data is read based on this calibration information. At 316, the calibration information may be stored and the device labeled as calibrated. Once the device has been calibrated, the process may move to 318, wherein it is determined if the position has changed. If so, then at 320 the device state position is updated. Then at 322 it is determined if the orientation has changed. If so, then at 324 the horizontal orientation may be updated. Then at 326, the relative positions between the receiving device and the control device can be updated. At 328, the horizontal selection list may be updated. This list comprises a listing of potential receiving devices the user is pointing to based upon the information received so far (position and horizontal orientation). At 330, it may be determined if the inclination has changed. If so, then at 332 the vertical orientation may be updated. Then at 334 a vertical item may be selected from the horizontal selection list, basically making the final determination of the user intent. Then at 336 the user intent may be emitted. It should be noted that 338 and 340 represent steps undertaken if the position has not changed at 318, but the results of these steps are the same as for 322 and 330, respectively.

The above flow can be described as a sequential collection of actions related to the change of value of one or more of the utilized sensors. The below table shows the actionable effect of the change in one or more sensor values, with Y designating that the sensor has changed.

TABLE 1

| | | | | | | | | |
|---|---|---|---|---|---|---|---|---|
| Position | N | N | N | N | Y | Y | Y | Y |
| Orientation | N | N | Y | Y | N | N | Y | Y |
| Inclination | N | Y | N | Y | N | Y | N | Y |
| Actions | A | B, C, | E, F, | E, F, | H, F, | H, F, | H, E, | H, E, |
| | | D | G, C, | G, B, | G, C, | G, B, | F, G, | F, G, |
| | | | D | C, D | D | C, D | C, D | B, C, |
| | | | | | | | | D |

Action List:
A No Change
B Update Vertical Orientation
C Select new vertical item from localized list
D Emit user Intent if any selected
E Update Horizontal Orientation
F Update relative positions from device positions and calibration data
G Rebuild localized list from relative positions
H Update device positions

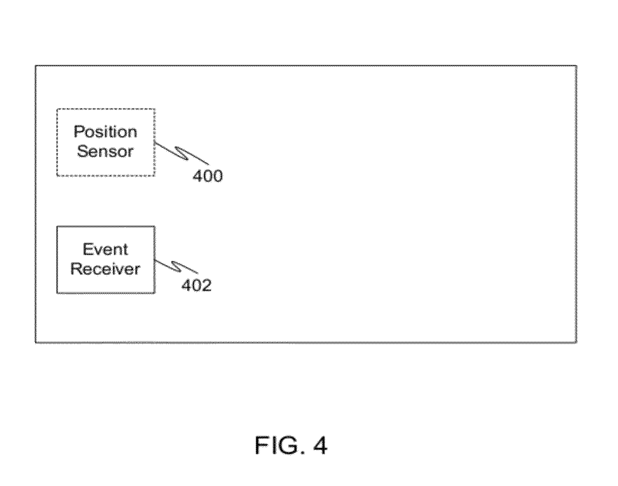

FIG. 4 is a block diagram illustrating the architecture of a receiving device in accordance with one embodiment of the present invention. This is a simplified version of the architecture, in that it would be expected that the receiving device would also contain various components related to its functioning as the device being controlled by the control device. For example, it would be expected that a television acting as a receiving device would also contain various components typically found in a television, such as a decoder, display, buttons or other controls, memory storing a user interface, etc. FIG. 4 merely depicts additional components designed to interact with a control device in order to effectuate the functions of the present invention. A position sensor 400 may be designed to track position of the control device when it is in proximity to the receiving device. It should be noted that this tracking may either be active or passive. In other words, the position sensor may take steps to itself detect the position of the receiving device, such as sending out sound waves (e.g., sonar). Alternatively, the position sensor may simply receive position updates transmitted from the control device.

An event receiver 402 is designed to receive an event generated by the control device. This device may indicate a pairing between the indicated receiving device and the control device based upon a determination that the position of the control device and the orientation of the control device evidence a user intent to control the indicated receiving device. This may include, for example, determining that the control device is pointing to an area within a distance threshold of the receiving device.

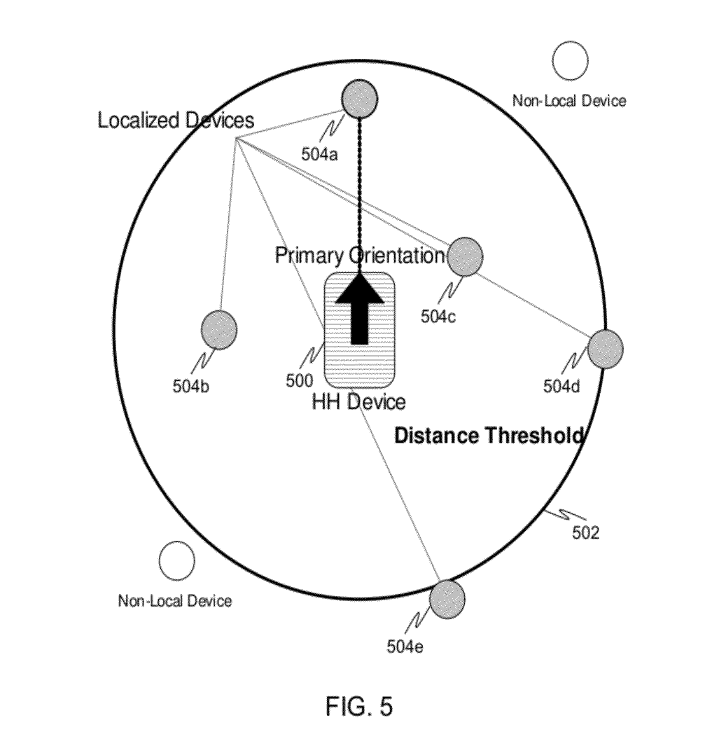

In one embodiment of the present invention, given a control device with a representable orientation and a collection of localizable devices inclusively determined by a threshold on distance, a user “intent” can be established by detecting a receiving device at which the device is “pointing” or “gesturing” toward. FIG. 5 depicts a top view of such a system. As can be seen, the control device 500 has a primary orientation, which is typically the orientation of the front/top of the device (as measured by, for example, an internal compass). There may be a distance threshold 502 which establishes the range in which localized devices can be controlled. Each localized device 504a-504e may have a mechanism for establishing the relative position of the handheld device with respect to itself (although as will be explained later, it is possible that some of the localized devices can still be controlled even though they do not have such a mechanism).

It should be noted that this mechanism to determine position of the control device may be included in each localized device 504a-504e separately, or may be made to work in conjunction with mechanisms in other localized devices. For example, localized device 504a may be built with a mechanism to determine the absolute position of the control device 500, or may be designed to simply measure the relative distance between the control device 500 and the localized device 504a and combine that information with similar measurements from other localized devices 504b-504e to “triangulate” a position for the handheld device.

Nevertheless, given information about the position of the control device 500 and the orientation of the control device 500, the localized device 504a directly in front of the control device 500 (and within the distance threshold 502) may be “selected” (or otherwise act accordingly as the user intent towards the device has been detected).

As described above, embodiments are provided that utilize particular parameters related to orientation and/or inclination with respect to the position of each device. These parameters establish a “state” or localized relation between the handheld device and one or more calibrated external devices. These parameters may be separated into horizontal and vertical values to explain their utilization.

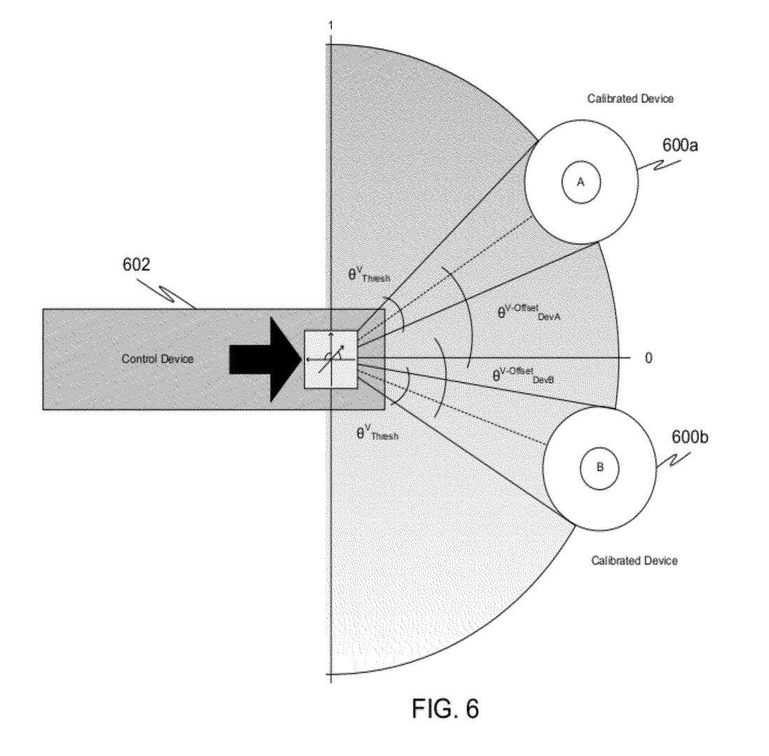

FIG. 6 is a diagram illustrating relative vertical inclination measuring in accordance with an embodiment of the present invention. Here, there are two calibrated receiving devices 600a, 600b. These devices are located on a different horizontal plane from each other (i.e., one of them is higher than the other). The relative vertical inclination from the control device 602 to each of the calibrated receiving devices 600a, 600b defines an angular value of reference between them. Each receiving device 600a, 600b can be represented by a smaller point surrounded by a larger area, to designate that the position of each device is also subject to a threshold to account for error in detection. The threshold with regard to each device is minimally fixed, but separately selected, to account for varying amounts of error.

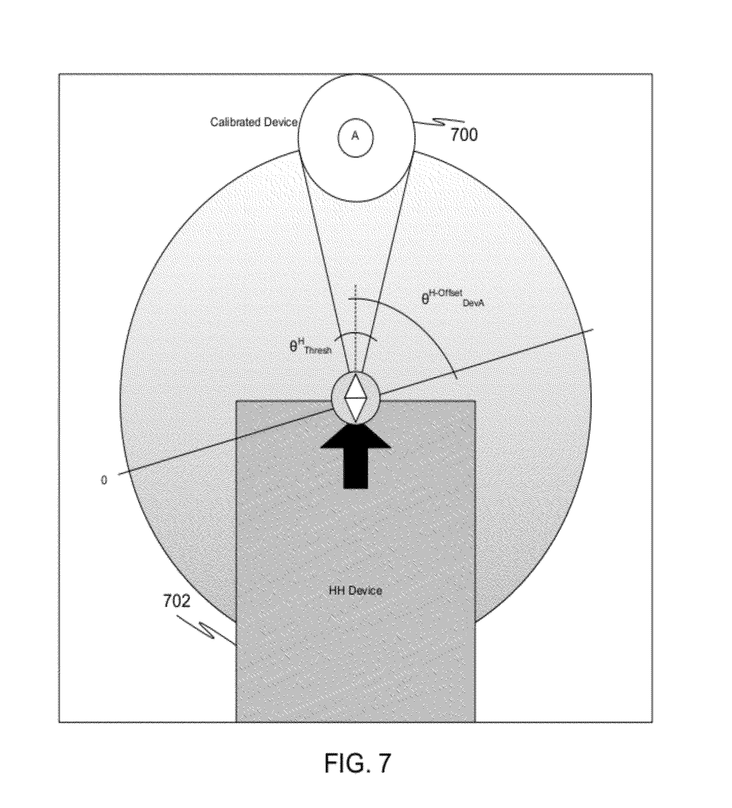

FIG. 7 is a diagram illustrating relative horizontal orientation measuring in accordance with an embodiment of the present invention. Here, there is a single calibrated receiving device 700. A present relative horizontal orientation between control device 702 and the receiving device 700 can be established defining an angular value of reference between them (established by some fixed arbitrary global orientation). Horizontally, devices are also subject to a threshold for detection as with the vertical case to account for error. This threshold is related to, but not explicitly dependent on or determined by, the device's vertical threshold.

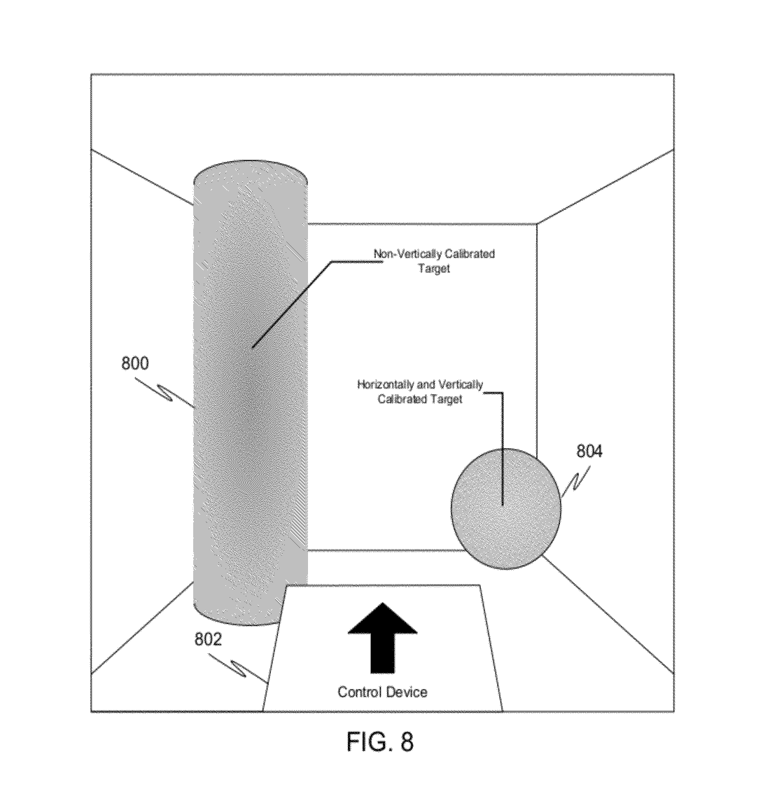

The vertical inclination is not explicitly required to be measured, and for cases with no vertical calibration data, the system simply will be able to judge which device in the horizontal plane is the focus of the user intent. FIG. 8 is a diagram illustrating pictorially a non-vertically calibrated target and a horizontally and vertically calibrated target in accordance with an embodiment of the present invention. Here, for the non-vertically calibrated target 800, the system will simply “see” a cylinder of infinite height with a radius equal to the horizontal threshold for the target. The system will be able to detect if the control device 802 is being pointed at this cylinder. Because this shape is a cylinder of infinite height, however, the system will not be able to differentiate between devices that share the same horizontal position but have different vertical positions, such as a stereo system positioned below a television.

If inclination information is also gathered, the system is able to utilize a horizontally and vertically calibrated target, which is represented by a sphere 804. The size of the sphere depends on the horizontal and vertical thresholds for the target. It should be noted that this shape may not be a true sphere, as if the horizontal threshold differs from the vertical threshold, the “sphere” may appear flattened in certain directions. However, for illustrative purposes a true sphere is depicted having a matching vertical and horizontal threshold. The shapes in this figure represent virtualizations of the shape of the space encompassing the receiving devises.

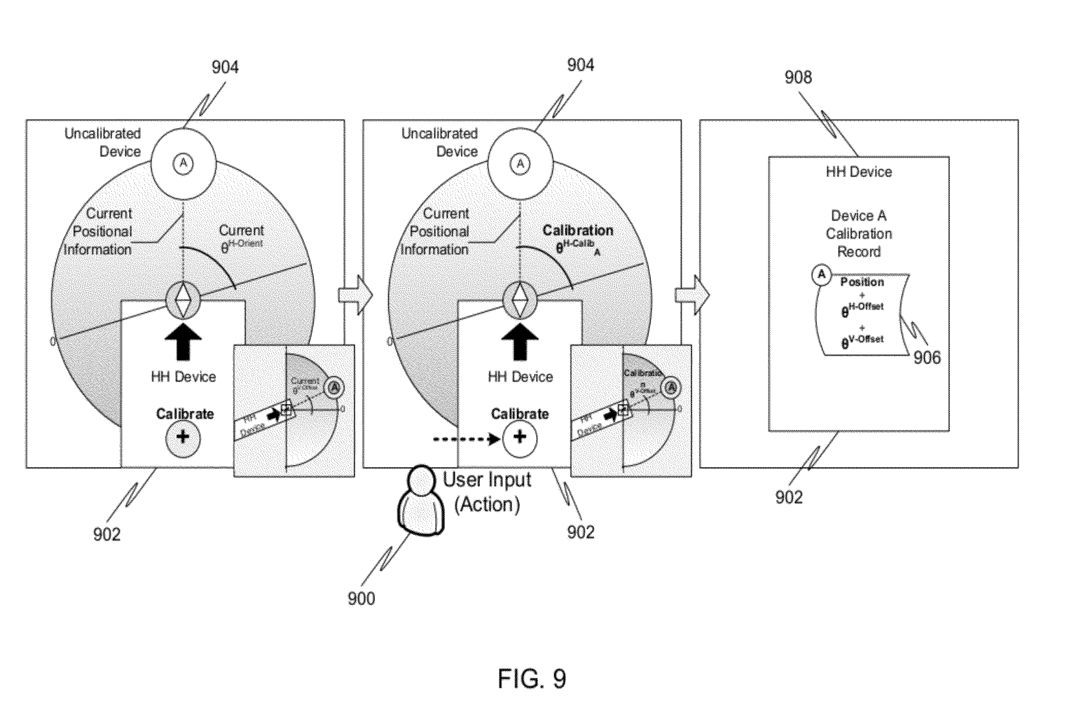

In order to properly perform tracking and intent detection, each device may provide at least a single calibration event provided by the device user. Calibration may involve establishing a calibration entry (record) for a new (uncalibrated) device. FIG. 9 is a diagram illustrating calibration in accordance with an embodiment of the present invention. Here, the user 900 points the control device 902 at an uncalibrated external receiving device 904. When the user 900 is confident of their orientation to that receiving device 904, the user 900 provides input to the system to calibrate that device, establishing a relative position, orientation, and possibly inclination with respect to the current position of the control device 902 at that time. This information 906 is stored within the system along with some form of identification 908 of the calibrated receiving device 904 in order to establish a baseline of position and orientation of the particular external device. This process should be executed a minimum of one time to establish a proper baseline, but may be executed multiple times to refine the accuracy of the baseline.

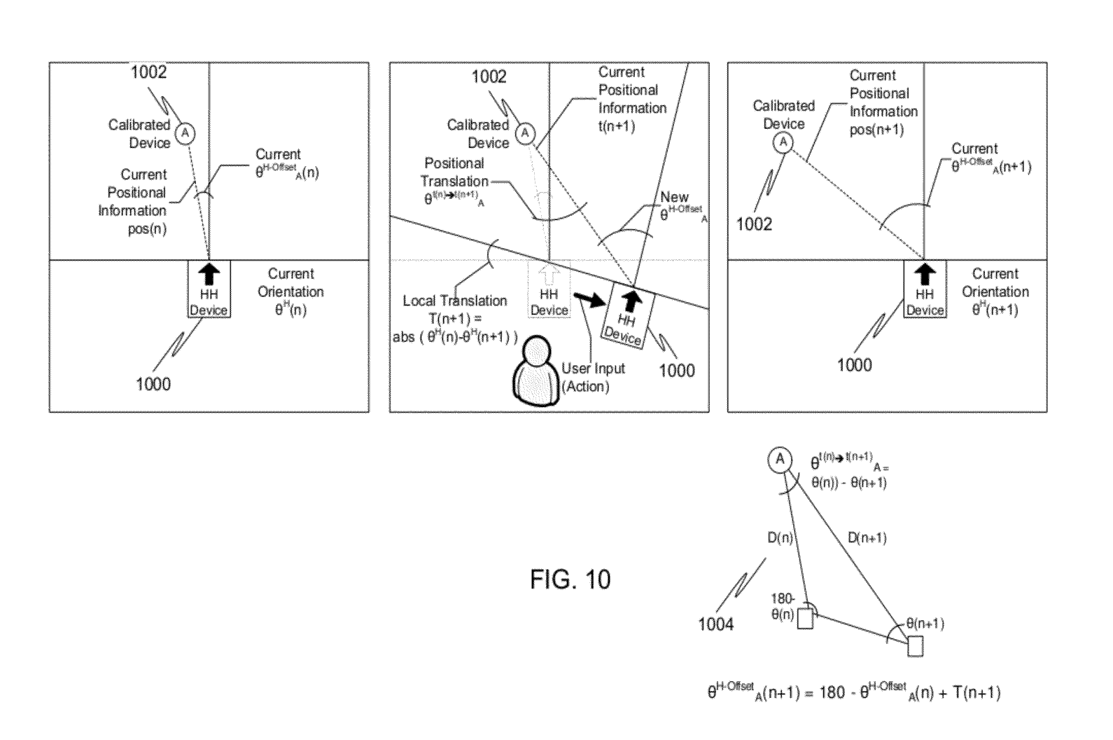

It should be noted that it may be necessary to ensure that the control device's state records of local devices are robust to translation or the movement by the user of the handheld device with respect to the external tracked devices. FIG. 10 is a diagram illustrating a process of translation between positions of a device in accordance with an embodiment of the present invention.

This example is limited to horizontal translation. In this example, the control device 1000 is both moved spatially as well as reoriented (rotated horizontally). The change in these parameters is determined by the change in the position and orientation of the control device 1000. With the results of this local translation of the control device 1000 as well as relative translation between the control device and the external receiving device 1002, the following calculation can be applied to determine the new orientation θ^{H-Offset}_{A.}

θ^{H-Offset}_{A.}(n+1)=180−θ^{H-Offset}_{A.}(n)+T(n+1). This is depicted graphically at 1004.

The process can be iteratively applied to all devices within the distance threshold of the handheld device, to establish proper tracking of all surrounding devices.

With the above-described system, given the current relative state parameters of each device, a user “intent” can be established simply as the minimization of the relative orientation difference between the handheld device and an external device. When this state is established, an intent is generated on behalf of the user and is available to any available internal system or external entity for utilization. For example, when used in the setting of device discovery, this could be used to “pair” the handheld device to an external device when it is pointed at it.

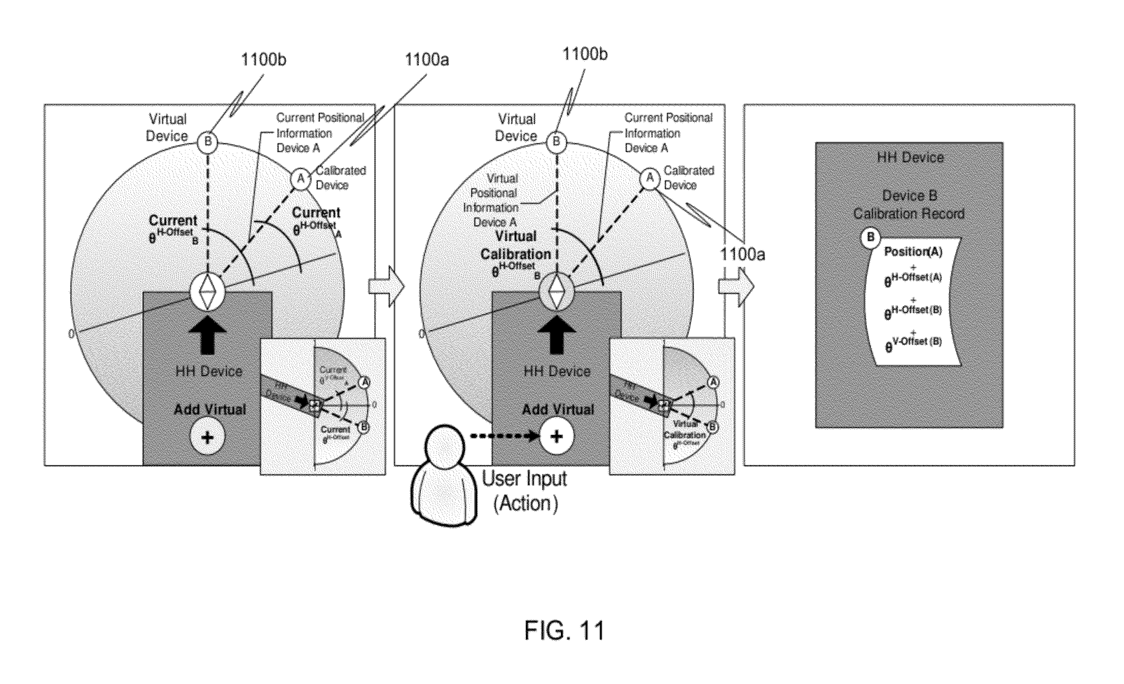

Additionally, the present invention also allows for the tracking and eventing of “virtual” devices, such as those which do not have available a system to effectively determine relative position to the handheld device. This virtual device calibration can be performed relative to a second, already calibrated device and this process may be virtually indistinguishable to the user, other than possibly the necessity of assigning some form of identification to the device. FIG. 11 is a diagram illustrating calibrating a virtual device in accordance with an embodiment of the present invention. Here, two receiving devices 1100a, 1100b are depicted, where receiving device 1100a has been calibrated previously by the control device 1102 and receiving device 1100b has no established positional data.

Like basic calibration, here the user 1104 points the control device 1102 at the virtual device 1100b and selects to add the device. The control device 1102, having an established position of receiving device 1100a can estimate a relative position of receiving device 1100b as a horizontal offset of the current relative position of receiving device 1100a, which is then stored as a calibration entry 1106 for receiving device 1100b. Then, when the control device 1102 calculates the position of receiving device 1100b through translation events, it first calculates the translation of receiving device 1100a and applies the offset translation of receiving device 1100b with respect to receiving device 1100a. In order to accomplish this, receiving device 1100b must be assigned a virtualized estimatable distance with respect to receiving device 1100a. In order to estimate a general distance to virtual devices, objects are assumed to be similarly planar and fixed to the walls of the space. In a generic case, the room would be considered circular and the position of one device would be inscribed at its relative position to another device, though any template for virtualized estimated layout could be used for placing virtual devices.

The system further provides iterative device recalibration with motion detection for dynamic “recalibration” of the system, either on a fixed interval or based on parameter changes, or alternatively using a thresholded evaluation of sensor value changes. When using sensors that produce continuous noise, utilizing a threshold for recalibration reduces sensor polling and the computational time of the tracking system. Explicitly, utilizing the incoming sensor values (accelerometer, gyroscope, compass, etc.) through a basic low-pass filter and a temporal threshold allows for the detection of user movement in order to establish qualifications for recalibration. Pairing this with an iterative timer allows the duration between timer events to be elongated when the user is more stationary and shortened when the user is moving more actively.

As such, the system disclosed herein provides three dimensional tracking of near-proximity fixed electronic devices based on continuous or intermittent polling of positional, orientation, and/or inclination sensors. The system further provides automatic user intent generation based on device orientation with respect to a compatible external receiving device. The system further provides virtualization of non-compatible fixed-point devices based on relativistic association with another compatible device. The system further provides iterative movement detection for reduction of processing time in sensor polling for multiple device tracking. The system further provides distributed calculation of proximity and orientation state (without a processing load on individual fixed devices). The system further provides a simple pointing interface to devices. The system further provides a differentiated solution for pointing-and-selecting.

It should also be noted that while the preceding description describes determining user intent based on position, orientation, inclination, and/or acceleration, there may be other movements that can be tracked and utilized to determine user intent. For example, the “roll” of the control device may be measured and used to aid in determining user intent, as could various button presses.

In another embodiment of the present invention, the user intent can also be determined with regard to a second user relative to a receiving device. The user may point their control device in the direction of another control device, allowing the system to detect and compare the relative orientations and positions of the devices and generate a user intent. For example, this could be used to simulate the dealing of a playing card from a deck of cards. Using the system of the present invention, the “dealer” will be able to deal playing cards to different players, distinguishing when the dealer is “flicking” a card to one user versus “flicking” the card to another. The corresponding screens on the various users' devices may be updated accordingly (e.g., the “dealer's” smartphone display may show a top card of a deck of cards sliding off in the direction of the user, whereas the appropriate “player's” smartphone display may show a card arriving from the direction of the dealer and being added to a hand of cards only visible on that particular player's smartphone display).

As will be appreciated to one of ordinary skill in the art, the aforementioned example architectures can be implemented in many ways, such as program instructions for execution by a processor, as software modules, microcode, as computer program product on computer readable media, as logic circuits, as application specific integrated circuits, as firmware, as consumer electronic device, etc. and may utilize wireless devices, wireless transmitters/receivers, and other portions of wireless networks. Furthermore, embodiment of the disclosed method and system for displaying multimedia content on multiple electronic display screens can take the form of an entirely hardware embodiment, an entirely software embodiment, or an embodiment containing both software and hardware elements.

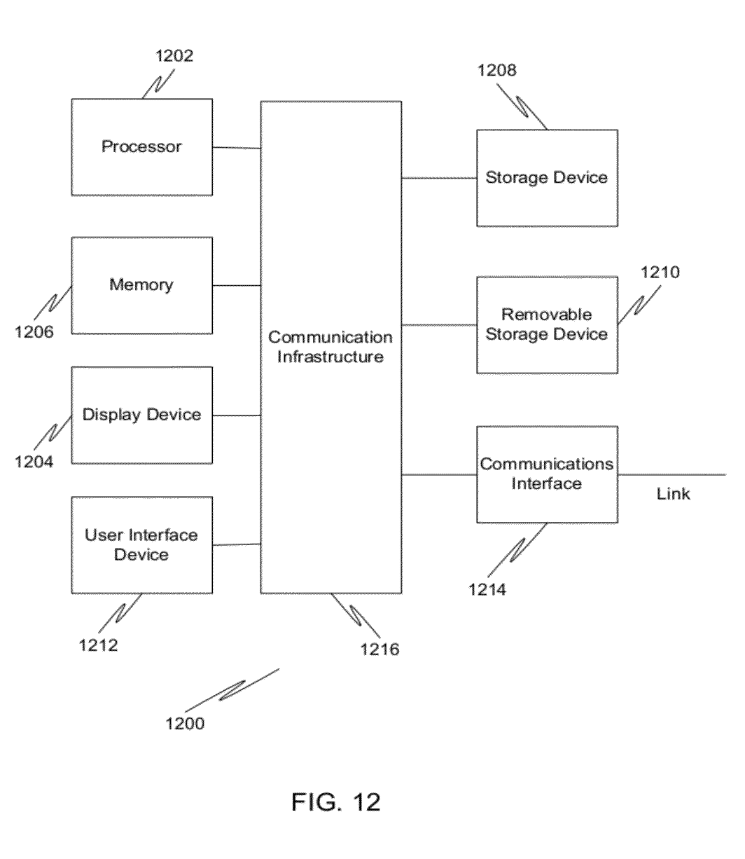

FIG. 12 is a high level block diagram showing an information processing system in accordance with an embodiment of the present invention. The computer system 1200 is useful for implementing an embodiment of the disclosed invention. The computer system 1200 includes one or more processors 1202, and further can include an electronic display device 1204 (for displaying graphics, text, and other data), a main memory 1206 (e.g., random access memory (RAM)), storage device 1208 (e.g., hard disk drive), removable storage device 1210 (e.g., optical disk drive), user interface devices 1212 (e.g., keyboards, touch screens, keypads, mice or other pointing devices, etc.), and a communication interface 1214 (e.g., wireless network interface). The communication interface 1214 allows software and data to be transferred between the computer system 100 and external devices via a link. The system may also include a communications infrastructure 1216 (e.g., a communications bus, cross-over bar, or network) to which the aforementioned devices/modules are connected.

Information transferred via communications interface 1214 may be in the form of signals such as electronic, electromagnetic, optical, or other signals capable of being received by communications interface 1214, via a communication link that carries signals and may be implemented using wire or cable, fiber optics, a phone line, a cellular phone link, a radio frequency link, and/or other communication channels. It should be noted that program storage devices, as may be used to describe storage devices containing executable computer code for operating various methods of the present invention, shall not be construed to cover transitory subject matter, such as carrier waves or signals. Program storage devices and computer readable medium are terms used generally to refer to media such as main memory, secondary memory, removable storage disks, hard disk drives, and other tangible storage devices or components.

The term “computer readable medium” is used generally to refer to media such as main memory, secondary memory, removable storage, hard disks, flash memory, disk drive memory, CD-ROM and other forms of persistent memory. It should be noted that program storage devices, as may be used to describe storage devices containing executable computer code for operating various methods of the present invention, shall not be construed to cover transitory subject matter, such as carrier waves or signals. Program storage devices and computer readable medium are terms used generally to refer to media such as main memory, secondary memory, removable storage disks, hard disk drives, and other tangible storage devices or components.

The various aspects, features, embodiments or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for controlling a receiving device, the method comprising:
detecting a position of a control device operated by a user;
detecting horizontal orientation or vertical inclination of the control device;
based on the position and the horizontal orientation or vertical inclination of the control device, determining that the control device is pointed at the receiving device as opposed to another receiving device in the vicinity; and
causing the control device to control the receiving device at which it is pointed based on the determination that the control device is pointed at the receiving device.

2. The method of claim 1, wherein the position is an absolute position.

3. The method of claim 1, wherein the position is a relative position between the control device and each of one or more receiving devices in the vicinity.

4. The method of claim 1, wherein the receiving device contains functionality to detect relative position between itself and the control device.

5. The method of claim 1, wherein the receiving device is a virtual receiving device in that it does not contain functionality to detect relative position between itself and the control device, but another receiving device in the vicinity does contain functionality to detect relative position between itself and the control device as well as knowledge of the relative position between itself and the receiving device at which the control device is pointed.

6. The method of claim 1, wherein the causing includes generating a pairing between the control device and the receiving device at which the control device is pointed.

7. A control device, comprising:
a position sensor designed to track position of the control device with respect to two or more receiving devices in proximity of the control device;
an orientation sensor designed to track horizontal orientation of the control device; and
an eventing module designed to determine at which of the two or more receiving devices the control device is pointing, based upon the tracked position and horizontal orientation, and to generate an event to the corresponding receiving device based upon that determination.

8. The control device of claim 7, further comprising:
an inclination sensor designed to track vertical inclination of the control device; and
wherein the eventing module is further designed to determine at which of the two or more receiving device the control device is pointing based also on the tracked vertical inclination.

9. The control device of claim 7, further comprising:
an acceleration sensor designed to track acceleration of the control device; and
wherein the eventing module is further designed to determine at which of the two or more receiving device the control device is pointing based also on the tracked acceleration.

10. The control device of claim 7, wherein the position sensor includes a component that interacts with a radio frequency identification (RFID) detector or other radio frequency transmission detection array.

11. The control device of claim 7, wherein the position sensor includes a component that measures distance using sonic waves.

12. The control device of claim 7, wherein the position sensor includes a global positioning system (GPS) module.

13. The control device of claim 7, wherein the position sensor includes a component that interacts with an optical distance detection and measurement component.

14. The control device of claim 7, wherein the orientation sensor is a compass.

15. The control device of claim 8, wherein the inclination sensor is a gyroscopic sensor.

16. A first receiving device, the first receiving device comprising:
a position sensor designed to track position of a control device in proximity of the first receiving device; and
an event receiver designed to receive an event generated by the control device, wherein the event indicates a pairing between an indicated receiving device and the control device based upon a determination that the position of the control device and the orientation of the control device evidence a user intent to control the indicated receiving device.

17. The first receiving device of claim 16, wherein the position sensor is a device that passively enables tracking by a control device.

18. The first receiving device of claim 16, wherein the indicated receiving device is the same as the first receiving device.

19. The first receiving device of claim 16, wherein the indicated receiving device is a second receiving device in proximity of the first receiving device, wherein the second receiving device contains no position sensor.

20. The first receiving device of claim 16, wherein the event is generated if it is determined that the position and orientation of the control device indicates that the control device is pointing to an area within a distance threshold of the first receiving device.

21. A system comprising:
a plurality of receiving devices;
a control device comprising;
means for detecting the position of the control device;
means for detecting horizontal orientation or vertical inclination of the control device;
means for, based on the position and the horizontal orientation or vertical inclination of the control device, determining that the control device is pointed at a particular one of the receiving devices as opposed to another receiving device in the vicinity; and
means for causing the control device to control the receiving device at which it is pointed.

22. The system of claim 21, wherein at least one of the receiving devices contains means for determining the position of the control device with respect to itself.

23. The system of claim 21, wherein at least one of the receiving devices contains means for determining the position of the control device with respect to another of the receiving device.
